(19) United States
(12) Patent Application Publication
(10) Pub. No.: US 2026/0131908 A1
(43) Pub. Date: May 14, 2026

(54) HOLDING SYSTEM

(71) Applicant: EXOLAUNCH GmbH, Berlin (DE)

(72) Inventors: Dmitriy Sternharz, Berlin (DE); Peter Schwarz, Salzburg (AT); Johannes Gruber, Salzburg (AT); Sergey Polyak, Berlin (DE)

(21) Appl. No.: 19/384,271

(22) Filed: Nov. 10, 2025

(30) Foreign Application Priority Data
Nov. 11, 2024 (EP) 24212150.7

(51) Int. Cl. B64G 1/64; F16H 21/54

(52) U.S. Cl. CPC B64G 1/641; F16H 21/54

(57) ABSTRACT

A holding system for releasably fastening a payload consists of four assemblies which are releasably connected to one another, namely two longitudinal members and two transverse members, and at which at least three holders are mounted that are adjustable between a release position and a locking position.

### CROSS REFERENCE TO RELATED APPLICATIONS

This application claims the benefit of foreign priority under 35 U.S.C. § 119 of European patent application number 24212150.7, filed Nov. 11, 2024. The contents of this application are incorporated herein by reference in their entirety.

### INTRODUCTION

The invention relates to a holding system for releasably fastening a payload. Such holding systems are used in space travel in order to transport a payload, such as satellites, by a fastening to a carrier rocket into a specific orbit and to detach and release said payload there. If the payload exceeds a certain size, the production, transport and installation of such a holding system can be problematic.

It is the object of the present invention to suggest a holding system for releasably fastening a payload, in which holding system the production, transport and assembly are simplified even in the case of a large payload.

This object is satisfied by the subject of claim 1. Advantageous further developments are defined in the dependent claims and can furthermore be seen from the description and the drawings.

### SUMMARY

The holding system according to the invention serves for the releasable fastening of a payload and consists of four assemblies that are releasably connected to one another, namely two longitudinal members and two transverse members. At least three holders that can be adjusted between a release position and a locking position are mounted at the assemblies.

In this respect, a holder can be provided at each assembly. However, it is also possible that no or more than just one holder is provided at an assembly.

The longitudinal members and the transverse members can in particular extend at right angles to one another so that the holding system has a square or rectangular basic shape in a plan view. The longitudinal members, on the one hand, and the transverse members, on the other hand, can be of different lengths. It is also possible for the longitudinal members and transverse members to be of the same length, which results in a square basic shape in a plan view. The longitudinal members and the transverse members are separate individual parts, i.e. individual, pre-installed or pre-installable assemblies that are in particular releasably connected to one another, for example, screwed to one another. A modular design of the holding system thereby results, whose individual assemblies are relatively compact and are thereby comparatively easy to produce, to transport, to assemble and to handle. Due to the modular design of the holding system, its handling is considerably facilitated since it is not the holding system as a whole that has to be transported, but rather the individual, much more compact assemblies.

One example of a payload is a satellite that can be coupled to a carrier rocket via the holding system, that can be transported by said carrier rocket into a specific orbit and that can be released from the carrier rocket there by adjusting the holders from the locking position into the release position. The holders couple or hold the payload to or at the holding system when they are in the locking position and release the payload from the holding system when they are in the release position.

For a synchronous adjustment of all the holders, each holder can be connected to each adjacent holder via a linkage. During an adjustment movement of a holder from the locking position into the release position, this adjustment movement can thus be transmitted via the linkage to the adjacent holder or the adjacent holders so that all the holders are adjusted synchronously.

Each holder can in particular be connected to a first adjacent holder via a first linkage and to a second adjacent holder via a second linkage. In this case, the holders of the holding system are mechanically connected in series in order to achieve a synchronous adjustment of all the holders.

The first linkage and/or the second linkage can have one or more, for example two, pivot levers. The pivot lever(s) can in particular be pivotably supported at at least one of the assemblies, for instance, at a transverse member. A pivot lever can in particular deflect or reverse the direction of the adjustment movement from one holder to its adjacent upstream or downstream holder. In particular, the respective linkage can consist of a first pivot lever and a second pivot lever as well as a rigid rod between the two pivot levers. The pivot levers can each be connected to one of the two holders and one of the ends of the rigid rod.

The assemblies can be provided with guides for the linkages so that the movement of the linkages is clearly defined.

The holders can be preloadable into the release position and the holding system can have a release unit which, in a locking state, holds the holders in the locking position against the preloading force and, in a release state, releases the holders for an adjustment into the release position. The preload can, for example, take place by springs, for instance compression springs. As long as the release unit is in the locking state, it prevents an adjustment movement from the locking position into the release position against the preloading force of the springs. If the release unit is set into the release state by a release, the release unit releases the holders so that they are adjusted from the locking position into the release position due to the preloading force.

The release unit can in particular engage at the linkage, for instance at one of the rigid rods of the linkage, and can hold the linkage so that the holders are prevented from being adjusted into the release position. The release unit can be controllable to release the linkage when a desired orbit is reached.

Each of the holders can be assigned its own preloaded ejection lever. Thus, the number of ejection levers at least corresponds to the number of holders. On a release, i.e. on an adjustment of the holders into the release position, the ejection levers are suitable for actively ejecting a component that is mounted at the payload and that was previously locked to the respective holder in the locking position in order to cause the release of the payload from the holding system.

A synchronization mechanism can be provided for a synchronous release of the ejection levers. The synchronization mechanism can have a pulling cable that engages at at least two ejection levers for the synchronous release of ejection levers, wherein the pulling cable is deflected by means of pulleys for the alignment of release movements such that said pulling cable crosses over at least once. At the point at which different sections of the pulling cable cross one another, these sections can be guided through a component along which sections of the pulling cable can slide, in particular to avoid a contact and a thereby produced friction between the cable sections. The component can have different separate planes or channels for this purpose, wherein the intersecting cable sections are guided through the different planes or channels. The component can, for example, be configured as a housing or a box.

To keep the cable under tension at all times, the pulling cable can be tensioned by at least one cable tensioner. The cable tensioner, which can be configured as a cable pulley, can be spring-loaded or non-spring-loaded.

In one embodiment, two assemblies can each have two ejection levers and the synchronization mechanism can, at each transverse member, have a transverse synchronization mechanism for a synchronous release of the two ejection levers of one of the two assemblies. The synchronization mechanism can furthermore, at the longitudinal members, have a longitudinal synchronization mechanism for a synchronous release of the ejection levers of the two assemblies. In other words, the two transverse synchronization mechanisms serve to trigger the two ejection levers of an assembly in a synchronized manner. The longitudinal synchronization mechanism, on the other hand, serves to synchronize the ejection levers of the two assemblies with one another so that all the ejection levers can be released synchronously. The transverse synchronization mechanism and the longitudinal synchronization mechanism thus have a similar function and can generally have a similar design.

The ejection levers can be coupled to the longitudinal synchronization mechanism via rods linearly guided at one of the assemblies. The rods can, for example, be fastened to pulling cables of the longitudinal synchronization mechanism so that they are moved along with the respective pulling cable.

The ejection levers can be formed scissor-like and can have two scissor levers that are connected in an articulated manner to one another. Furthermore, the ejection levers can each have a first bearing section and a second bearing section, at which bearing sections one end of one of the two scissor levers is connected in an articulated manner in each case. In this respect, the first bearing section can be supported in a stationary manner at one of the assemblies and the second bearing section can be guided in a linearly travelable manner at one of the assemblies. The second bearing section can be connected to the synchronization mechanism for a synchronous release, in particular to the longitudinal synchronization mechanism and to the respective transverse synchronization mechanism.

### BRIEF DESCRIPTION OF THE DRAWINGS

The invention will be explained in a purely exemplary manner in the following with reference to an embodiment example schematically shown in the drawings. There are shown

FIG. 1 a perspective view of a holding system according to an embodiment example;

FIG. 2 a perspective lower view of the holding system of FIG. 1;

FIG. 3 a perspective detailed view from below of a holder, a linkage and an ejection lever of the holding system of FIG. 1;

FIG. 4 a plan view of the lower side of a transverse member of the holding system of FIG. 1, wherein the holders are in the locking position;

FIG. 5 a plan view in accordance with FIG. 4, wherein the holders are in the release position;

FIG. 6 a perspective detailed view of an upper side of a holder and an ejection lever of the holding system of FIG. 1;

FIG. 7 the perspective detailed view in accordance with FIG. 6, wherein the transverse member is masked; and

FIG. 8 a cross-sectional view of a bearing section of an ejection lever and of the guidance thereof by a transverse member of the holding system of FIG. 1.

### DETAILED DESCRIPTION

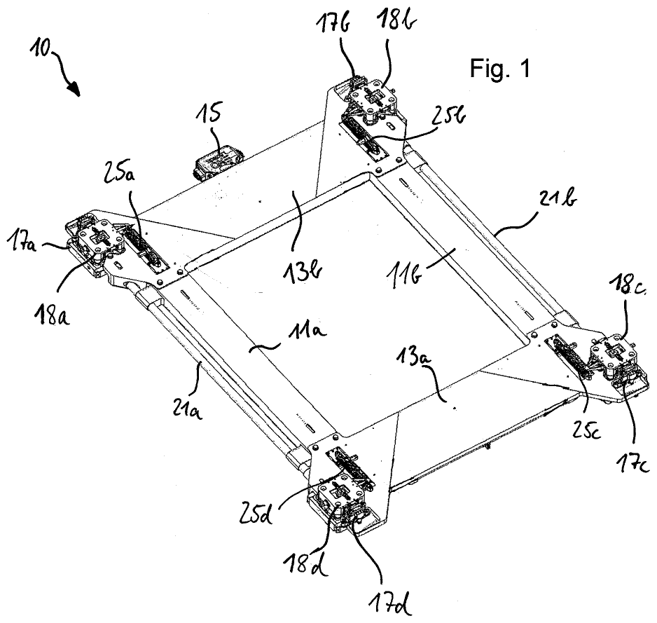

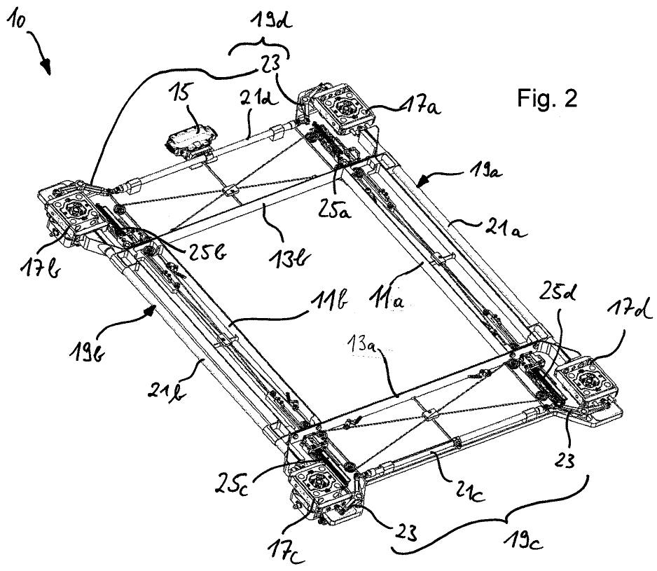

A holding system 10 is shown in a perspective view in FIGS. 1 and 2, wherein FIG. 1 shows the upper side and FIG. 2 shows the lower side of the holding system 10. Said holding system consists of two longitudinal members 11a, 11b spaced apart in parallel and two transverse members 13a, 13b spaced apart in parallel. The longitudinal members 11a, 11b extend at right angles to the transverse members 13a, 13b so that the holding system 10 has a square basic shape in a plan view and also has a rectangular basic shape in the embodiment example shown. The longitudinal members 11a, 11b and the transverse members 13a, 13b are separate modules, i.e. assemblies, that are in particular releasably connected to one another. In the embodiment example shown, the assemblies are screwed together via screw connections 59a, 59b, 59c, 59d, wherein other and also non-releasable connection means are of course also possible. In the present embodiment example, the longitudinal members 11a, 11b and the transverse members 13a, 13b are each characterized by a tub-like design.

Four identical holders 17a, 17b, 17c, 17d, which can be adjusted between a release position and a locking position, are mounted at the assemblies 11a, 11b, 13a, 13b. The holders 17a, 17b, 17c, 17d are configured in a generally known manner such that a holding component 18a, 18b, 18c, 18d of the payload is fixed to them when the respective holder 17a, 17b, 17c, 17d is in the locking position and is released from the holder 17a, 17b, 17c, 17d when the respective holder 17a, 17b, 17c, 17d is in the release position. The four holding components 18a, 18b, 18c, 18d are mounted at the payload so that the entire holding system 10 with the payload can be transported into a specific orbit by means of a carrier rocket. If the holders 17a, 17b, 17c, 17d are moved from the locking position into the release position, the payload can be released and ejected.

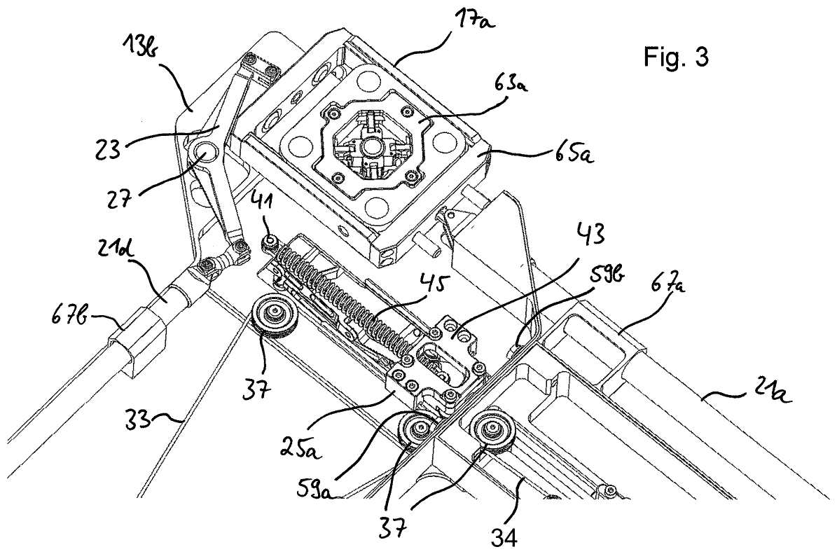

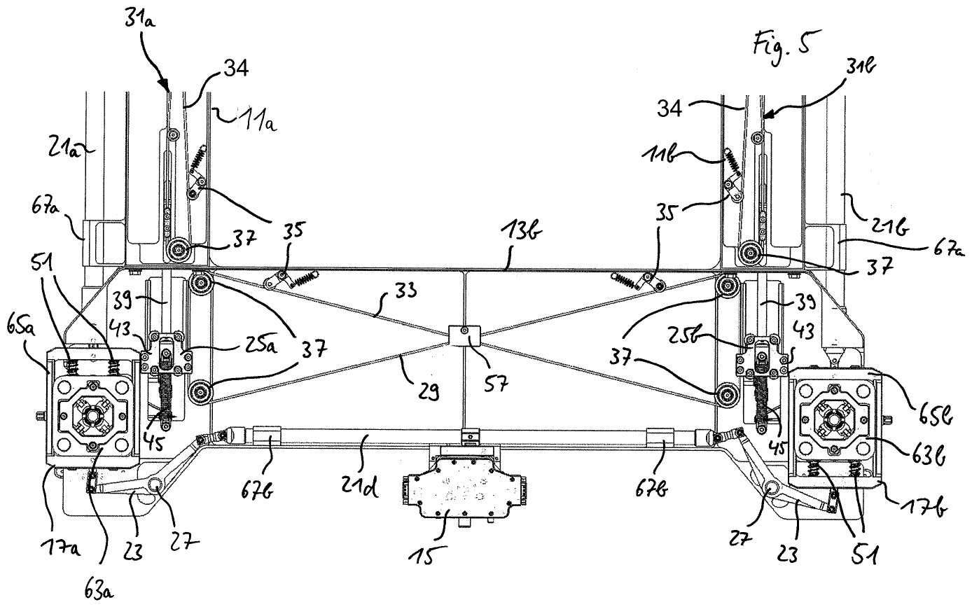

With reference to FIGS. 3 to 6, the basic design of the holders is explained below with reference to the two holders 17a, 17b. Said holders each have a locking unit 63a, 63b mounted in a stationary manner at the respective assembly 11a, 11b, 13a, 13b and a frame-shaped release element 65a, 65b that can be displaced in a translatory manner relative to the respective locking unit 63a, 63b. The displacement of the release element 65a, 65b between its two end positions corresponds to an adjustment movement from the locking position into the release position or vice versa. The displacement therefore leads to a locking or unlocking of the locking unit 63a, 63b that in turn has a locking mechanism, not shown or described in more detail, that locks the respective fastening component of the payload in the locking position and releases it in the release position. The release elements 65a, 65b and thus also the holders 17a, 17b, 17c, 17d are preloaded into the release position by compression springs 51 (FIG. 5).

To ensure a trouble-free release of the payload, the adjustment of the holders 17a, 17b, 17c, 17d takes place synchronously. In the present case, this takes place in that each holder 17a, 17b, 17c, 17d is connected to its two adjacent holders 17a, 17b, 17c, 17d via a linkage 19a, 19b, 19c, 19d in each case. The linkages 19a, 19b, 19c, 19d are configured and connected to the holders 17a, 17b, 17c, 17d such that they transmit the adjustment movement of a respective holder 17a, 17b, 17c, 17d from the locking position into the release position to both adjacent holders 17a, 17b, 17c, 17d. Due to this mechanical compulsory coupling, a temporally synchronous release, i.e. a simultaneous release, of all four holders 17a, 17b, 17c, 17d results.

In the present embodiment example, there are four linkages 19a, 19b, 19c, 19d corresponding to the number of holders 17a, 17b, 17c, 17d. Two linkages 19c, 19d extend parallel to the two transverse members 13a, 13b and the other two linkages 19a, 19b extend parallel to the two longitudinal members 11a, 11b.

The two linkages 19a, 19b, which extend parallel to the longitudinal members 11a, 11b, each consist of a rigid rod 21a, 21b that is connected at its two ends to the two holders 17a, 17b, 17c, 17d and that is guided in a translatory manner by guides 67a of the longitudinal members 11a, 11b.

The two linkages 19c, 19d extending parallel to the transverse members 13a, 13b likewise each have a rigid rod 21c, 21d. The rods 21c, 21d of these two linkages 19c, 19d are guided in a translatory manner by guides 67b of the transverse members 13a, 13b and, as in particular FIG. 3 shows, are connected in an articulated manner at their two ends to one end of a pivot lever 23 in each case. The pivot lever 23 is pivotably supported at the respective transverse member 13 by a bolt or a pin 27 and comprises two legs extending away from the axis of the bolt or the pin 27, the free ends of said legs being connected in an articulated manner to the respective rod 21c, 21d or being connected in an articulated manner to a holder 17a, 17b, 17c, 17d. The adjustment movement of adjacent rods, e.g. the rods 21a and 21d, can be inverted by the pivot levers 23, i.e., on a pushing movement of the rod 21a, the rod 21d performs a pulling movement so that the adjustment movement of the holders 17a, 17b, 17c, 17d at the oppositely disposed longitudinal members 11a, 11b is directed in the opposite direction.

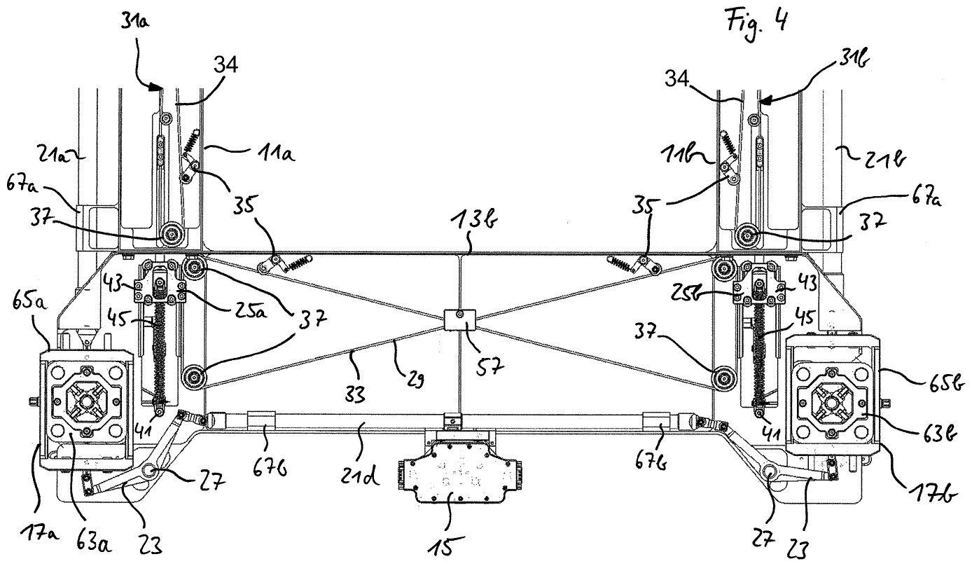

FIGS. 4 and 5 show a plan view of the lower side of a transverse member 13b of the holding system 10, wherein the two holders 17a, 17b are shown in the locking position in FIG. 4 and in the release position in FIG. 5. The holders 17a, 17b are preloaded into the release position by the relaxed compression springs 51 visible in FIG. 5. To eject the payload, an electrically controllable release unit 15 is provided that engages at the rod 21d of the linkage connecting the two holders 17a, 17b and fixes the rod 21d against the preload of the compression springs 51 in the non-controlled state, see FIG. 4. When the release unit 15 is controlled, it releases the rod 21d. Due to the preload of the compression springs 51, the holders 17a, 17b or their release elements 65a, 65b are adjusted into the release position in so doing, whereby, as previously mentioned, the locking mechanisms of the locking units 63a, 63b open and release the respective fastening component of the payload. The linkages thus effect a simultaneous release of the payload fixed in the holders.

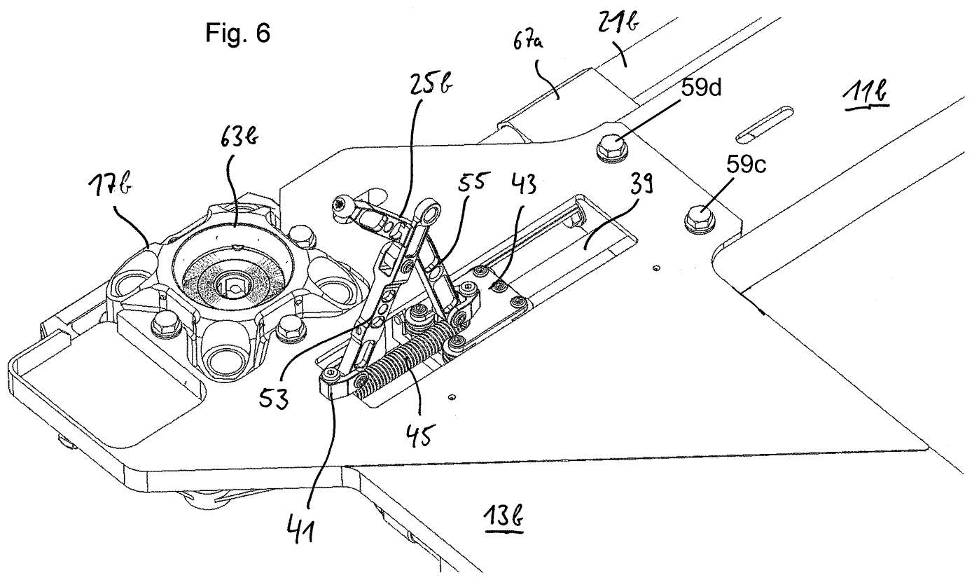

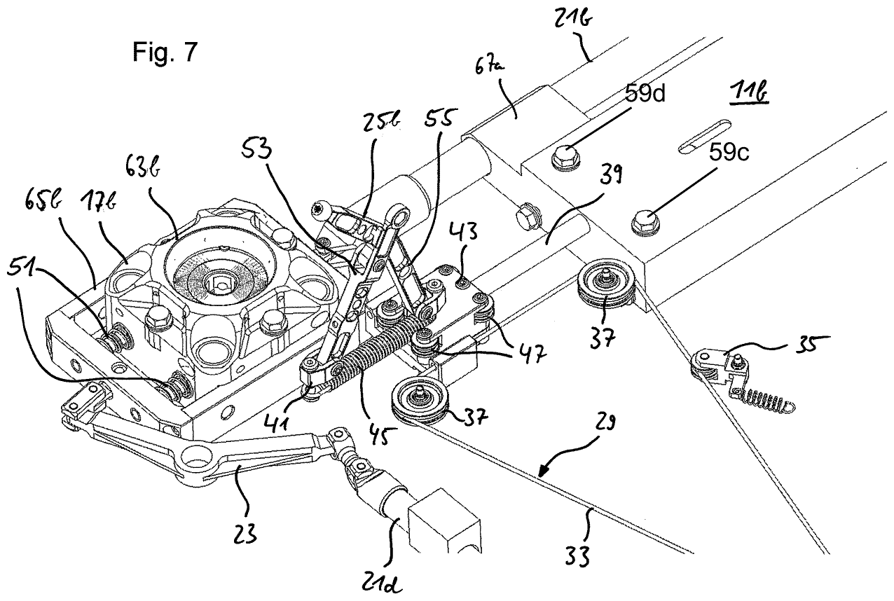

In the present embodiment example, the holding system 10 further has four ejection levers 25a, 25b, 25c, 25d, namely an ejection lever 25a, 25b, 25c, 25d that is arranged next to a holder 17a, 17b, 17c, 17d in each case. The ejection levers 25a, 25b, 25c, 25d are formed scissor-like with two scissor levers 53, 55 each and move into the ejection position shown in FIGS. 6 and 7 on their release, wherein the outer free end of the scissor levers 55 contacts the payload in order to apply a force to the payload during the ejection.

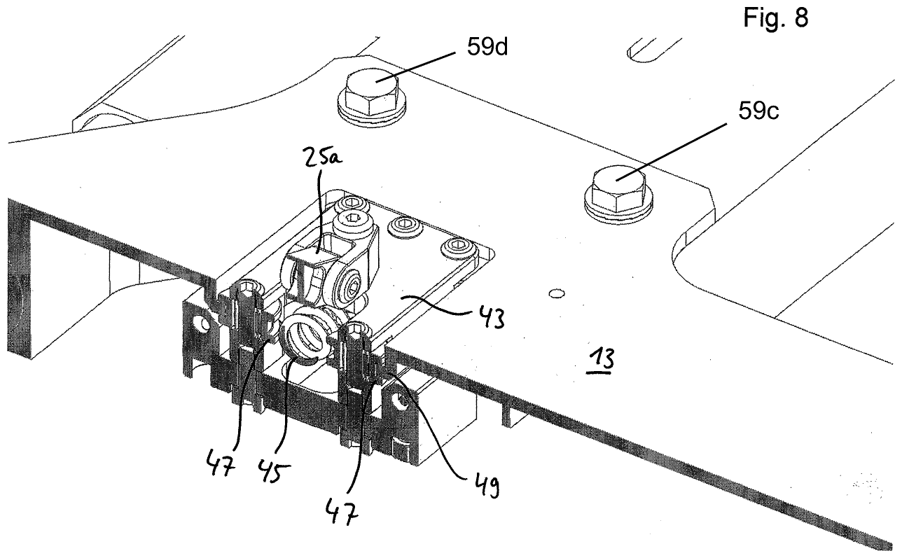

As in particular FIGS. 6 and 7 show, the ejection levers 25a, 25b, 25c, 25d each have a first bearing section 41 supported in a stationary manner at the respective transverse member 13a, 13b and a second bearing section 43 that can be linearly moved at the respective transverse member 13a, 13b, wherein the one scissor lever 53 is fastened to the first bearing section 41 and the other scissor lever 55 is fastened to the second bearing section 43. The bearing sections 41, 43 are preloaded by a tension spring 45 into the ejection position shown in FIGS. 6 and 7 and are held in the position shown in FIG. 4 against the preloading force before the release or ejection by the payload. As in particular FIG. 8 shows, the second bearing section 43 is linearly guided by rollers 47 at a rail geometry 49 of the respective transverse member 13. If the holders 17a, 17b, 17c, 17d are adjusted into the release position, the preloaded ejection levers 25a, 25b, 25c, 25d can relax and exert an ejection impulse on the payload.

For a synchronous release of the ejection levers 25a, 25b, 25c, 25d, a synchronization mechanism is furthermore provided that has a transverse synchronization mechanism 29 at each transverse member 13a, 13b and a longitudinal synchronization mechanism 31a, 31b at the longitudinal members 11a, 11b in each case.

The transverse synchronization mechanism 29 of a transverse member 13b can in particular be seen from FIGS. 4 and 5, wherein the other transverse member 13a has a transverse synchronization mechanism of the same design. The transverse synchronization mechanism 29 synchronizes the movement of the two ejection levers 25 of the transverse member 13b. For this purpose, the transverse synchronization mechanism 29 comprises an endless pulling cable 33 that is deflected by means of pulleys 37 and that is fastened to the second bearing sections 43 of the two ejection levers 25 so that it is moved along with them. For an alignment of release movements, the cable 33 is deflected so that it crosses over once. At the point of intersection, the endless cable 33 is guided through a component that is designed purely by way of example as a box 57 in the present embodiment example. Sections of the pulling cable 33 can slide along the component 57. In its interior, the box 57 has separate planes or channels to prevent friction between the intersecting sections of the pulling cable 33.

During the ejection and the associated movement of the second bearing sections 43 from the position shown in FIG. 4 into the position shown in FIG. 5, the pulling cable 33 is moved along accordingly in order to synchronize the release of the ejection levers 25 present at the transverse member 13b.

Similarly, longitudinal synchronization mechanisms 31a, 31b are provided that synchronize the movement of the ejection levers 25 of the two transverse members 13a, 13b with one another. The longitudinal synchronization mechanisms 31 also comprise a pulling cable 34 that is deflected by means of pulleys 37 and that likewise has intersecting sections that extend through separate planes or channels of a component that is similar or identical to the sliding component 57 mentioned above. The pulling cable 34 of the longitudinal synchronization mechanisms 31a, 31b is in each case fastened in a stationary manner to rods 39 that are guided in a linearly travelable manner at the respective longitudinal members 11a, 11b so that a movement of the rod 39 causes a corresponding movement of the pulling cable 34 and vice versa. The rod 39 is fastened in a stationary manner to the second bearing section 43 of the respective ejection lever 25.

In order to keep the pulling cables 33, 34 of the synchronization mechanism under tension at all times, spring-loaded cable pulleys 35 (FIG. 7) are provided, along which the respective pulling cable 33, 34 extends.

Reference numeral list

| | |
|---|---|
| 10 | holding system |
| 11a, 11b | longitudinal member |
| 13a, 13b | transverse member |
| 15 | release unit |
| 17a-17d | holder |
| 18a-18d | holding component |
| 19a-19d | linkage |
| 21a-21d | rod |
| 23 | pivot lever |
| 25a-25d | ejection lever |
| 27 | pin |
| 29 | transverse synchronization mechanism |
| 31a, 31b | longitudinal synchronization mechanism |
| 33 | pulling cable |
| 34 | pulling cable |
| 35 | cable pulley |
| 37 | pulley |
| 39 | rod |
| 41 | bearing section |
| 43 | bearing section |
| 45 | tension spring |
| 47 | roller |
| 49 | rail geometry |
| 51 | compression spring |
| 53 | scissor lever |
| 55 | scissor lever |
| 57 | box |
| 59a-59d | screw |
| 63a, 63b | locking unit |
| 65a, 65b | release element |
| 67a, 67b | guide |

1. A holding system for releasably fastening a payload, said holding system consisting of four assemblies that are releasably connected to one another, namely two longitudinal members and two transverse members, wherein at least three holders that are adjustable between a release position and a locking position are mounted at the assemblies.

2. The holding system according to claim 1, wherein, for a synchronous adjustment of all the holders, each holder is connected to each adjacent holder via a linkage.

3. The holding system according to claim 2, wherein each holder is connected to a first adjacent holder via a first linkage and to a second adjacent holder via a second linkage.

4. The holding system according to claim 3, wherein the first linkage and/or the second linkage has a pivot lever.

5. The holding system according to claim 2, wherein the assemblies are provided with guides for the linkages.

6. The holding system according to claim 1, wherein the holders can be preloaded into the release position and the holding system has a release unit that, in a locking state, holds the holders in the locking position against the preloading force and, in a release state, releases the holders for an adjustment into the release position.

7. The holding system according to claim 1, wherein each holder is assigned its own preloaded ejection lever.

8. The holding system according to claim 7, comprising a synchronization mechanism for a synchronous release of the ejection levers.

9. The holding system according to claim 8, wherein, for a synchronous adjustment of all the holders, each holder is connected to each adjacent holder via a linkage, and wherein the synchronization mechanism is decoupled from the linkages.

10. The holding system according to claim 8, wherein the synchronization mechanism has a pulling cable that engages at at least two ejection levers for the synchronous release of ejection levers, wherein the pulling cable is deflected by means of pulleys for the alignment of release movements such that said pulling cable crosses over at least once.

11. The holding system according to claim 10, comprising a component through which intersecting sections of the pulling cable are guided through separate planes or channels.

12. The holding system according to claim 10, wherein the pulling cable is tensioned by at least one cable tensioner.

13. The holding system according to claim 8, wherein two assemblies each have two ejection levers and the synchronization mechanism has, at each transverse member, a transverse synchronization mechanism for a synchronous release of the two ejection levers of one of the two assemblies, and wherein the synchronization mechanism has, at the longitudinal members, a longitudinal synchronization mechanism for a synchronous release of the ejection levers of the two assemblies.

14. The holding system according to claim 13, wherein the ejection levers are coupled to the longitudinal synchronization mechanism via rods guided at one of the assemblies.

15. The holding system according to claim 8, wherein the ejection levers each have two scissor levers, a first bearing section, at which one end of a first scissor lever is supported in an articulated manner, and a second bearing section, at which one end of a second scissor lever is supported in an articulated manner, and wherein the first bearing section is supported in a stationary manner at one of the assemblies and the second bearing section is guided in a linearly travelable manner at one of the assemblies, and wherein the second bearing section is connected to the synchronization mechanism for a synchronous release.

16. The holding system according to claim 4, wherein the pivot lever is pivotably supported at at least one of the assemblies.
